(19) United States
(12) Patent Application Publication
(10) Pub. No.: US 2022/0024534 A1
(43) Pub. Date: Jan. 27, 2022

(54) Carrying aid for bicycle

(71) Applicant: Kiran Shankarayogi, Secaucus, NJ (US)

(72) Inventor: Kiran Shankarayogi, Secaucus, NJ (US)

(21) Appl. No.: 16/934,043

(22) Filed: Jul. 21, 2020

(51) Int. Cl. B62J 50/10; A45F 5/00

(52) U.S. Cl. CPC B62J 50/10; A45F 5/00

(57) ABSTRACT

This disclosure relates generally to a rack for transport of a bicycle on the shoulder. The rack holds the bicycle from un-necessary movement and reduces stress on the shoulder while carrying the bicycle.

### BACKGROUND

### Copyright Notice

A portion of the disclosure of this patent document contains material which is subject to copyright protection. The copyright owner has no objection to the facsimile reproduction by anyone of the patent document or the patent disclosure, as it appears in the Patent and Trademark Office patent file or records, bit otherwise reserves all copyright rights whatsoever.

### FIELD OF THE INVENTION

An bike carrying rack on the shoulder is disclosed. The bicycle carrying rack is unique and is provided for fastening the bicycle carrying rack to the shoulder of the user.

### DESCRIPTION OF THE RELATED ART

In most cases a bicycle when in need of storage or transport is either handled without protection or contained within a rather cumbersome box typically having a volume double that of the bicycle itself. Even with such large sized containers they usually do not provide effective protection from piercing-type objects, from falls, or from the weather. A number attempts have been made to improve the transport and storage of bicycles and these are represented by the following U.S. Pat. No. 4,149,634 Lewis, Jr. U.S. Pat. No. 3,949,528 Hartger U.S. Pat. No. 3,929,225 Locke U.S. Pat. No. 3,886,988 Garrett U.S. Pat. No. 3,865,166 Pedro U.S. Pat. No. 3,734,272 Galen U.S. Pat. No. 3,079,172 Burwell.

From review of these patents and other publications that one might incur, it is apparent that none of the containers meet the full needs of the modern bicycle owner, Likewise, when the need occurs to transport a bicycle on a vehicle such as an automobile, typically the bicycle is transported on a pair of hooks secured to a U-shaped frame upstanding from the bumper of the vehicle. The bicycle is thus subject to full inclement weather or possible damage from gravel and stones, or other objects thrown up during transport.

Also, the containers available for bicycles add significantly to the weight and at the same time are of such bulk and weight that they are difficult, if not impossible, for one person to carry. Even the corrugated cardboard boxes often used by airlines for transport of bicycles are of such bulk that even with a lightweight bicycle contained therein, two persons are required to carry such a container, and poor hand-holds are provided. The wasted cubage of such a container which is in the shape of a rectilinear three-dimensional box is a critical loss of storage space.

However, to Applicant's knowledge, none of these prior art methods have been found to be completely suitable to meet these needs and are cumbersome and non-durable. Hence, the inventor of the present invention proposes to resolve and surmount existent technical difficulties and to eliminate the aforementioned shortcomings of prior art. The overall combination of these features is nowhere disclosed in the prior art cited above which appears to be representative of the general art in this area although it is not intended to be an all-inclusive listing of pertinent prior art patents.

### SUMMARY

In light of the disadvantages of the prior art, the following summary is provided to facilitate an understanding of some of the innovative features unique to the present invention and is not intended to be a full description. A full appreciation of the various aspects of the invention can be gained by taking the entire specification, claims, drawings, and abstract as a whole.

According to a first embodiment the invention is able to carry a Bicycle on the shoulders, for example while taking steps, where you need to carry you bike on the shoulder.

Embodiments of the invention reduces stress on the shoulder while carrying the bicycle.

Another object of the invention is to provide a bicycle support which is easily transported by one person over the shoulder.

This Summary is provided merely for purposes of summarizing some example embodiments, so as to provide a basic understanding of some aspects of the subject matter described herein. Accordingly, it will be appreciated that the above-described features are merely examples and should not be construed to narrow the scope or spirit of the subject matter described herein in any way. Other features, aspects, and advantages of the subject matter described herein will become apparent from the following Detailed Description, Figures, and Claims.

### BRIEF DESCRIPTION OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 100 shows the schematic view of the invention.

FIG. 200 shows another perspective view of the invention.

FIG. 300 shows top perspective view of the invention.

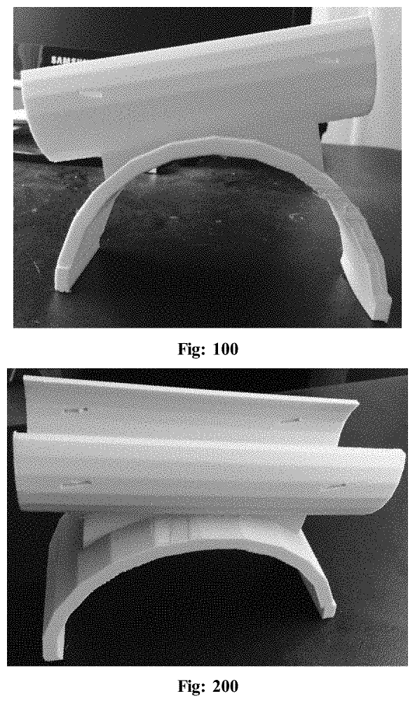

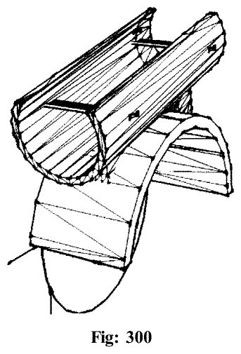

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

Before explaining the invention in detail, it is to be understood that the invention is not limited in its application to the detail of construction and arrangement of parts ilustrated in the drawings since the invention is capable of other embodiments and of being practiced or carried out in various ways. It is also to be understood that the phraseology or terminology employed is for the purpose of description only and not of limitation.

Considering the advances the invention is to attach the product to the bicycle at the top tube underneath the seat. The invention acts as a bike carrying product on the shoulder and reduces stress on the shoulder while carrying the bicycle.

The use of the invention is simple without any tedious effort. The invention is a shoulder wearable rack that is attached to the top rod at the junction where seat rod and the seat clamp meet. The invention will solely be used to carry bike on the shoulder without the need of additional devices

It is an additional object of the present invention to provide an improved bicycle rack that is easily stowed in an upright position bit which is also easily used by unskilled or first-time users.

With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separately claimed subject matter.

1. A bike rack comprising:
a frame; and
a main unit rack; where,
a frame as per claim 1 is “C” shaped which acts as an external frame;
a frame as per claim 1 is carried on individual's shoulder;
a rain unit rack as per claim 1 is “U” shaped; and,
a main unit rack attached to the product top rod to rest on individual's shoulder.

2. A bike rack to hold the bicycle securely which is developed from rigid material usually metal allowing to retain its consistency and usage over loner period of time.
